(19) United States
(12) Patent Application Publication
(10) Pub. No.: US 2009/0086078 A1
(43) Pub. Date: Apr. 2, 2009

(54) IMAGING DEVICE DRIVING METHOD AND IMAGING APPARATUS

(75) Inventor: Mikio WATANABE, Miyagi (JP)

Correspondence Address: BIRCH STEWART KOLASCH & BIRCH, PO BOX 747, FALLS CHURCH, VA, 22040-0747, US

(73) Assignee: FUJIFILM Corporation, Tokyo (JP)

(21) Appl. No.: 12/211,199

(22) Filed: Sep. 16, 2008

(30) Foreign Application Priority Data
Sep. 28, 2007 (JP) 2007-256703

(51) Int. Cl. H04N 5/335

(52) U.S. Cl. 348/311; 348/E05.091

(57) ABSTRACT

An aspect of the invention is directed to a method for driving the imaging device as defined herein, in which a smear suppression driving operation which applies a transfer pulse to the transfer electrodes to transfer the charge is executed in such a manner that a standby place of the charge in the vertical charge transfer path for a horizontal transfer period for transferring the charge through the horizontal charge transfer path is at the vertical charge transfer path provided below the transfer electrode other than the transfer electrode which is adjacent to any of the photoelectric converting devices which has a detected wavelength on the shortest wavelength side.

### CROSS-REFERENCE TO RELATED APPLICATIONS

This application claims the benefit of Japanese Patent Application JP 2007-256703, filed Sep. 28, 2007, the entire content of which is hereby incorporated by reference, the same as if set forth at length.

### FIELD OF THE INVENTION

The present invention relates to a method of driving an imaging device having plural types of photoelectric converting devices for detecting lights in different wavelength ranges from each other, a vertical charge transfer path for transferring charges generated in the photoelectric converting devices in a vertical direction, and a horizontal charge transfer path for transferring the charges transferred through the vertical charge transfer path in a horizontal direction which is orthogonal to the vertical direction.

### BACKGROUND OF THE INVENTION

In an imaging apparatus such as a digital camera or a digital video camera which includes a CCD (Charge Coupled Device) type image sensor as an imaging device, there is a problem in that a smear to be a peculiar phenomenon to the CCD is generated when photographing is carried out without using a mechanical shutter. JP-UM-B-6-41425 Publication has disclosed a method of removing the smear.

### SUMMARY OF THE INVENTION

In the method disclosed in JP-UM-B-6-41425 Publication, however, a line memory and an adder-subtractor are required for removing the smear. Therefore, there is a problem in that a cost is increased and a mounting area is enlarged in a whole imaging apparatus system.

In consideration of the circumstances, it is an object of the invention to provide a method of driving an imaging device and an imaging apparatus which can lessen the influence of a smear without adding a special circuit.

The invention provides a method of driving an imaging device having plural types of photoelectric converting devices for detecting lights in different wavelength ranges from each other, a vertical charge transfer path for transferring charges generated in the photoelectric converting devices in a vertical direction, and a horizontal charge transfer path for transferring the charges transferred through the vertical charge transfer path in a horizontal direction which is orthogonal to the vertical direction, wherein the imaging device has transfer electrodes which are arranged in the vertical direction above the vertical charge transfer path and serve to control a charge transfer operation in the vertical charge transfer path, and a smear suppression driving operation for applying a transfer pulse to the transfer electrodes to transfer the charge is executed in such a manner that a standby place of the charge in the vertical charge transfer path for a horizontal transfer period for transferring the charge through the horizontal charge transfer path serves as the vertical charge transfer path provided below the transfer electrode other than the transfer electrode which is adjacent to any of the photoelectric converting devices which has a detected wavelength on the shortest wavelength side.

In the method of driving an imaging device according to the invention, the imaging device includes a photoelectric converting device for detecting a light in a wavelength range having a red color, a photoelectric converting device for detecting a light in a wavelength range having a green color, and a photoelectric converting device for detecting a light in a wavelength range having a blue color.

In the method of driving an imaging device according to the invention, when it is possible to select a first photographing mode for controlling an exposing period of the imaging device by using a mechanical shutter and a second photographing mode for controlling the exposing period of the imaging device by means of only an electronic shutter without using the mechanical shutter, the smear suppression driving operation is executed only in the case in which a photographing operation is carried out in the second photographing mode.

In the method of driving an imaging device according to the invention, only in the case in which a saturation capacity of the photoelectric converting device is equal to or smaller than a maximum amount of charges which can be stored in the standby place when the smear suppression driving operation is carried out, the smear suppression driving operation is executed.

In the method of driving an imaging device according to the invention, when it is possible to select a first photographing mode for controlling an exposing period of the imaging device by using a mechanical shutter and a second photographing mode for controlling the exposing period of the imaging device by means of only an electronic shutter without using the mechanical shutter, the smear suppression driving operation is executed only in the case in which a photographing operation is carried out in the second photographing mode and a saturation capacity of the photoelectric converting device is equal to or smaller than a maximum amount of charges which can be stored in the standby place in the execution of the smear suppression driving operation.

The method of driving an imaging device according to the invention comprises the steps of deciding whether a smear is generated or not based on an imaging signal output from the imaging device through a preliminary imaging operation carried out before a main imaging operation, and executing the smear suppression driving operation only when the smear is generated.

The invention provides an imaging apparatus comprising an imaging device having plural types of photoelectric converting devices for detecting lights in different wavelength ranges from each other, a vertical charge transfer path for transferring charges generated in the photoelectric converting devices in a vertical direction, and a horizontal charge transfer path for transferring the charges transferred through the vertical charge transfer path in a horizontal direction which is orthogonal to the vertical direction, and a driving unit for driving the imaging device, wherein the imaging device has transfer electrodes which are arranged in the vertical direction above the vertical charge transfer path and serve to control a charge transfer operation in the vertical charge transfer path, and the driving unit executes a smear suppression driving operation for applying a transfer pulse to the transfer electrodes to transfer the charge in such a manner that a standby place of the charge in the vertical charge transfer path for a horizontal transfer period for transferring the charge through the horizontal charge transfer path serves as the vertical charge transfer path provided below the transfer electrode other than the transfer electrode which is adjacent to any of the photoelectric converting devices which has a detected wavelength on the shortest wavelength side.

In the imaging apparatus according to the invention, the plural types of photoelectric converting devices include a photoelectric converting device for detecting a light in a wavelength range having a red color, a photoelectric converting device for detecting a light in a wavelength range having a green color, and a photoelectric converting device for detecting a light in a wavelength range having a blue color.

In the imaging apparatus according to the invention, it is possible to select a first photographing mode for controlling an exposing period of the imaging device by using a mechanical shutter and a second photographing mode for controlling the exposing period of the imaging device by means of only an electronic shutter without using the mechanical shutter, and the driving unit executes the smear suppression driving operation only in the case in which a photographing operation is carried out in the second photographing mode.

In the imaging apparatus according to the invention, only in the case in which a saturation capacity of the photoelectric converting device is equal to or smaller than a maximum amount of charges which can be stored in the standby place when the smear suppression driving operation is carried out, the driving unit executes the smear suppression driving operation.

In the imaging apparatus according to the invention, it is possible to select a first photographing mode for controlling an exposing period of the imaging device by using a mechanical shutter and a second photographing mode for controlling the exposing period of the imaging device by means of only an electronic shutter without using the mechanical shutter, and the driving unit executes the smear suppression driving operation only in the case in which a photographing operation is carried out in the second photographing mode and a saturation capacity of the photoelectric converting device is equal to or smaller than a maximum amount of charges which can be stored in the standby place when the smear suppression driving operation is carried out.

The imaging apparatus according to the invention comprises a smear generating presence deciding unit for deciding whether a smear is generated or not based on an imaging signal output from the imaging device through a preliminary imaging operation carried out before a main imaging operation, the driving unit executing the smear suppression driving operation only when it is decided that the smear is generated by the smear generating presence deciding unit.

According to the invention, it is possible to provide a method of driving an imaging device and an imaging apparatus which can lessen the influence of a smear without adding a special circuit.

### BRIEF DESCRIPTION OF THE DRAWINGS

FIG. 1 is a diagram showing a schematic structure of a digital camera according to an example of an imaging apparatus for explaining a first embodiment of the invention,

FIG. 2 is a typical plan view showing an example of a structure of an imaging device to be provided in the digital camera illustrated in FIG. 1,

FIG. 3 is a timing chart for a transfer pulse supplied from an imaging device driving portion to the imaging device in a smear suppression driving operation in the digital camera illustrated in FIG. 1,

FIG. 4 is a chart showing an optical absorption wavelength dependency of silicon,

FIG. 5 is a view for explaining a method of deciding presence of generation of a smear,

FIG. 6 is a typical plan view showing a schematic structure of an imaging device to be provided in a digital camera according to a third embodiment,

FIG. 7 is a timing chart for a transfer pulse supplied from an imaging device driving portion to the imaging device according to the third embodiment when the imaging device is driven through a smear suppression driving operation,

FIG. 8 is a timing chart showing an example of a general driving operation in which a saturation capacity of a photoelectric converting device is maintained in place of the smear suppression driving operation in the imaging device illustrated in FIG. 6,

FIG. 9 is a typical plan view showing a schematic structure of an imaging device to be provided in a digital camera according to a fourth embodiment, and

FIG. 10 is a timing chart for a transfer pulse supplied from an imaging device driving portion to the imaging device according to the fourth embodiment when the imaging device is driven through the smear suppression driving operation.

### DESCRIPTION OF THE REFERENCE NUMERALS AND SIGNS

5 imaging device
51 photoelectric converting device
52 vertical charge transfer path
53 horizontal charge transfer path
54 output portion
V1 to V4 transfer electrode

### DETAILED DESCRIPTION OF THE INVENTION

An embodiment according to the invention will be described below with reference to the drawings.

### First Embodiment

An imaging device which will be described in a first embodiment can be provided for use in an imaging apparatus such as a digital camera or a digital video camera. Description will be given to a structure of a digital camera according to an example of the imaging apparatus including the imaging device.

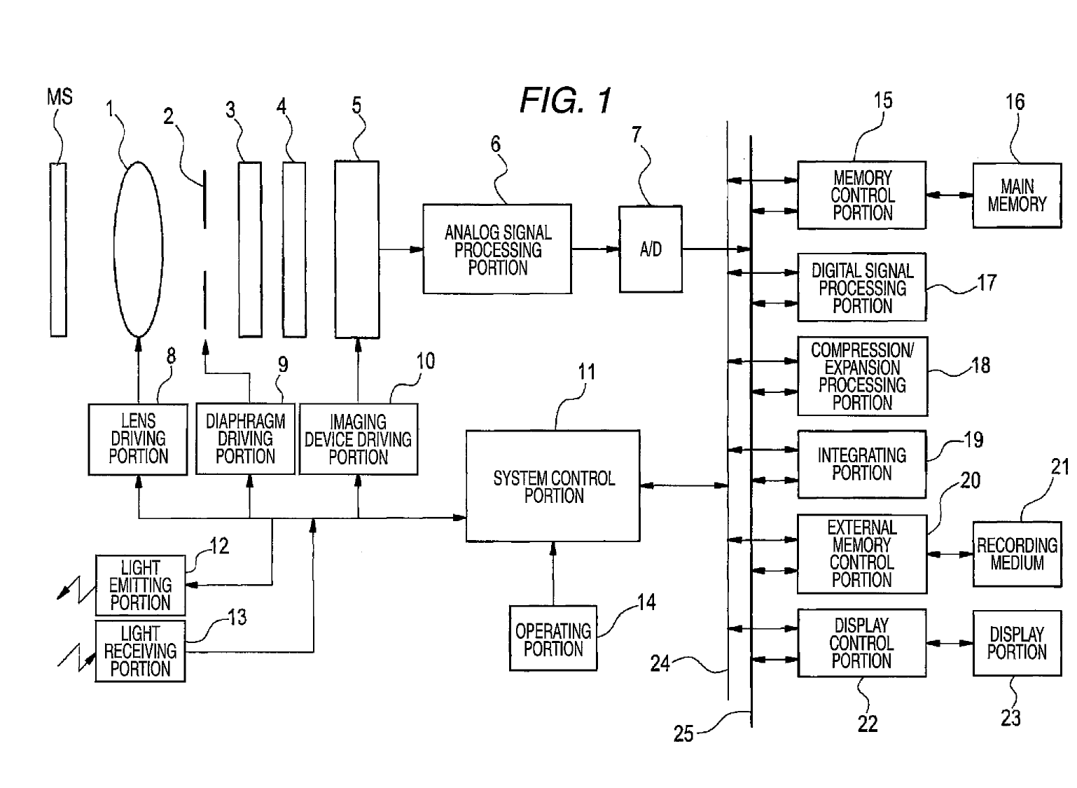

FIG. 1 is a diagram showing a schematic structure of the digital camera according to the example of the imaging apparatus for explaining the first embodiment of the invention.

An imaging system of the digital camera shown in FIG. 1 includes a taking lens 1, an openable mechanical shutter MS provided on a whole surface of the taking lens 1, a CCD type imaging device 5, and a diaphragm 2, an infrared cut filter 3 and an optical low-pass filter 4 which are provided between the taking lens 1 and the imaging device 5.

A system control portion 11 for chiefly controlling a whole electric control system of the digital camera controls a flash light emitting portion 12 and a light receiving portion 13 and controls a lens driving portion 8 to adjust a position of the taking lens 1 into a focusing position or to carry out zooming, and controls an opening amount of the diaphragm 2 to regulate an exposing amount through a diaphragm driving portion 9.

Moreover, the system control portion 11 drives the imaging device 5 through an imaging device driving portion 10 to output, as a color signal, an object image picked up through the taking lens 1. An instruction signal is input from a user to the system control portion 11 through an operating portion 14.

The electric control system of the digital camera further includes an analog signal processing portion 6 which is connected to an output of the imaging device 5 and serves to carry out an analog signal processing such as a correlated double sampling processing, and an A/D converting circuit 7 for converting color signals of R. G and B output from the analog signal processing portion 6 into digital signals, and they are controlled by the system control portion 11.

In addition, the electric control system of the digital camera includes a main memory 16, a memory control portion 15 connected to the main memory 16, a digital signal processing portion 17 for carrying out an interpolating calculation, a gamma correcting calculation and an RGB/YC conversion processing to generate image data, a compression and expansion processing portion 18 for compressing the image data generated in the digital signal processing portion 17 into a JPEG form and expanding the compressed image data, an integrating portion 19 for integrating photometric data to calculate a gain of a white balance correction carried out by the digital signal processing portion 17, an external memory control portion 20 to which a removable recording medium 21 is connected, and a display control portion 22 to which a liquid crystal display portion 23 provided on a back face of the camera is connected, and they are mutually connected through a control bus 24 and a data bus 25 and are controlled in accordance with a command sent from the system control portion 11.

The digital camera can set at least a first photographing mode (for example, a still picture photographing mode) for controlling an exposing period of the imaging device 5 by using the mechanical shutter MS to carry out a photographing operation and a second photographing mode (for example, a moving picture photographing mode) for controlling the exposing period of the imaging device 5 by using only an electronic shutter in place of the mechanical shutter MS to carry out the photographing operation.

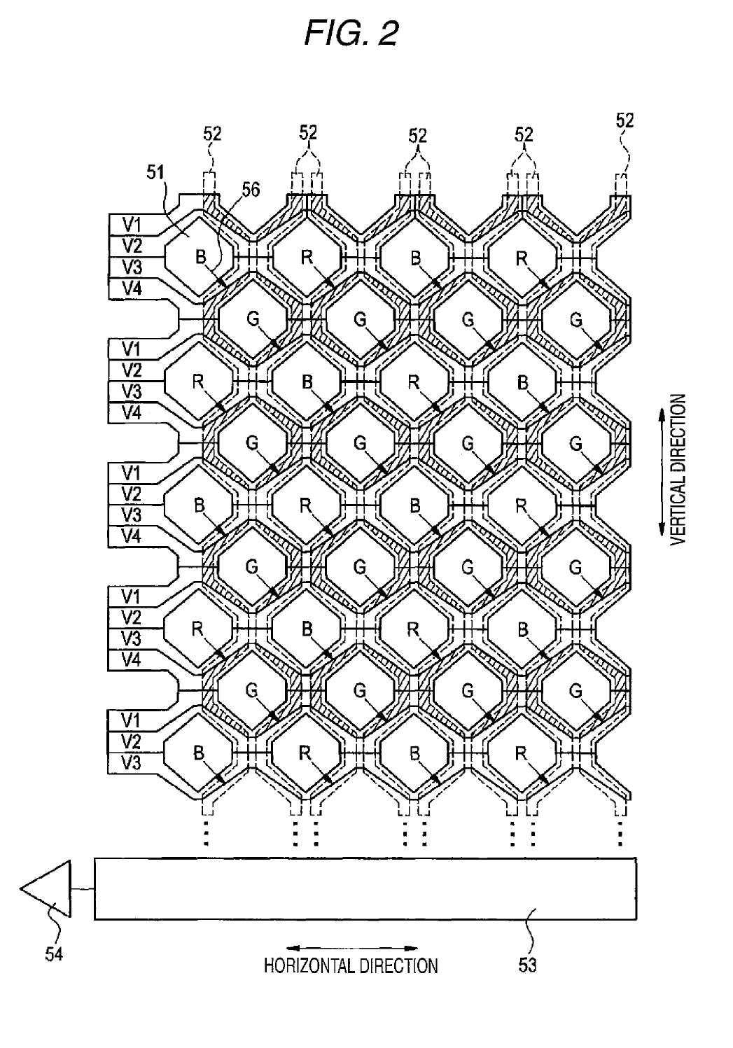

FIG. 2 is a typical plan view showing an example of a structure of the imaging device provided on the digital camera illustrated in FIG. 1.

The imaging device shown in FIG. 2 includes a large number of photoelectric converting devices 51 constituted by silicon photodiodes arranged two-dimensionally in a vertical direction and a horizontal direction which is orthogonal thereto in a semiconductor substrate, a plurality of vertical charge transfer paths 52 for transferring charges generated in the photoelectric converting devices 51 in the vertical direction, a horizontal charge transfer path 53 for transferring the charges transferred through the vertical charge transfer paths 52 in the horizontal direction, and an output portion 54 for converting the charge transferred through the horizontal charge transfer path 53 into a voltage signal and outputting the voltage signal.

The photoelectric converting devices 51 are constituted by three types of photoelectric converting devices including an R photoelectric converting device (indicated as a character of “R” in FIG. 2) for detecting a light (R light) in a wavelength range having a red color, a G photoelectric converting device (indicated as a character of “G” in FIG. 2) for detecting a light (G light) in a wavelength range having a green color, and a B photoelectric converting device (indicated as a character of “B” in FIG. 2) for detecting a light (B light) in a wavelength range having a blue color.

The photoelectric converting devices 51 are arranged in a so-called honeycomb array in which each of a photoelectric converting device group having the R photoelectric converting device 51 and the B photoelectric converting device 51 arranged like a square grid and a photoelectric converting device group having the G photoelectric converting device 51 arranged like a square grid is shifted by a half of each of photoelectric converting device array pitches in the vertical direction and the horizontal direction.

The vertical charge transfer path 52 is provided in a right side portion corresponding to a photoelectric converting device line formed by the photoelectric converting devices 51 arranged in the vertical direction and transfers, in the vertical direction, the charge generated in each of the photoelectric converting devices 51 in the corresponding photoelectric converting device line. A charge reading portion 56 (typically shown in an arrow in the drawing) for reading the charge generated in the photoelectric converting device 51 onto the vertical charge transfer path 52 is provided between the vertical charge transfer path 52 and the photoelectric converting device 51 corresponding thereto.

Transfer electrodes V1, V2, V3 and V4 are arranged in the vertical direction above the vertical charge transfer path 52. A 4-phase transfer pulse is supplied from the imaging device driving portion 10 to the transfer electrodes V1 to V4, for example, and a charge transfer operation in the vertical charge transfer path 52 is thus controlled. The transfer electrodes V1 and V3 also cover the charge reading portion 56 provided corresponding to the photoelectric converting device 51 respectively. By applying a reading pulse having a high level to the transfer electrodes V1 and V3, it is possible to control the charge reading operation from the photoelectric converting devices 51 to the vertical charge transfer path 52. The transfer pulse can take three states having a high (H) level (for example, 15V), a middle (M) level (for example, 0V) and a low (L) level (for example, −8V).

The imaging device driving portion 10 executes, in the second photographing mode, a smear suppression driving operation for applying the transfer pulse to the transfer electrodes V1 to V4 to transfer the charge in such a manner that a standby place of the charge in the vertical charge transfer path 52 for the horizontal transfer period for transferring the charge through the horizontal charge transfer path 53 is set to be the vertical charge transfer path 52 below the transfer electrode (V1, V4) other than the transfer electrode (V2, V3) which is adjacent to the photoelectric converting device (the B photoelectric converting device) having a detected wavelength on the shortest wavelength side in the photoelectric converting devices 51. The smear suppression driving operation will be described below in detail.

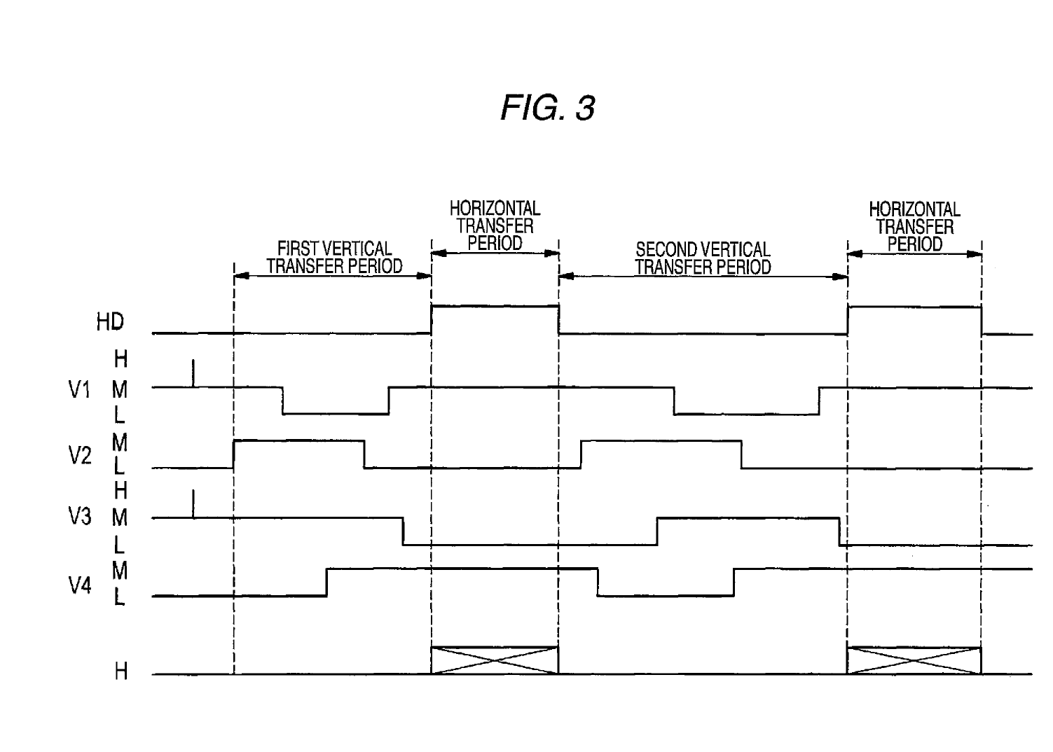

FIG. 3 is a timing chart for the transfer pulse supplied from the imaging device driving portion 10 to the imaging device 5 in the smear suppression driving operation.

The photographing operation is carried out in the second photographing mode. When an exposing period is ended, electric potentials of the transfer electrodes V1 and V3 are set into the middle level so that a packet is formed in the vertical charge transfer path 52 below the transfer electrodes V1 and V3. Then, the electric potentials of the transfer electrodes V1 and V3 are set into the high level so that a charge is read from the photoelectric converting device 51 onto the packet. Next, the transfer pulse is controlled for only a first vertical transfer period as shown in FIG. 3. By the control, the packet storing the charge read from the C photoelectric converting device 51 is transferred from a portion provided below the transfer electrode V1 to portions provided below the adjacent transfer electrode V4 on a downstream side in a charge transfer direction of the transfer electrode V1 and the transfer electrode V1 which is adjacent thereto, and the packet storing the charge read from each of the R photoelectric converting device 51 and the B photoelectric converting device 51 is transferred from a portion provided below the transfer electrode V3 to portions provided below the adjacent transfer electrode V4 on a downstream side in a charge transfer direction of the transfer electrode V3 and the transfer electrode V1 which is adjacent thereto.

For the first vertical transfer period, the charges read from the photoelectric converting devices 51 corresponding to two lines which are close to the horizontal charge transfer path 53 are transferred to the horizontal charge transfer path 53. Then, a horizontal transfer period is started by a rise of a horizontal synchronizing signal HD and a 2-phase transfer pulse is applied to the horizontal charge transfer path 53, for example, and the charge transferred to the horizontal charge transfer path 53 is transferred to the output portion 54 and a signal corresponding to the transferred charge is output from the output portion 54. For the horizontal transfer period, the charge read from the photoelectric converting device 51 is brought into a state in which it stands by in the vertical charge transfer paths 52 provided below the transfer electrodes V1 and V4 (portions shown in hatching of FIG. 2).

When the horizontal transfer period is ended by a fall of the horizontal synchronizing signal, the second vertical transfer period is started so that the charges present below the transfer electrodes V4 and V1 are transferred to portions provided below the transfer electrodes V4 and V1 which are adjacent on the downstream side in the charge transfer direction of the transfer electrodes V4 and V1. Then, the horizontal transfer period is started by the rise of the horizontal synchronizing signal HD, the charge transferred to the horizontal charge transfer path 53 is transferred to the output portion 54 and a signal corresponding to the transferred charge is output from the output portion 54.

Subsequently, the second vertical transfer period and the horizontal transfer period are repeated alternately so that signals corresponding to the charges generated in all of the photoelectric converting devices 51 are output from the output portion 54 and an imaging operation corresponding to one frame is thus ended.

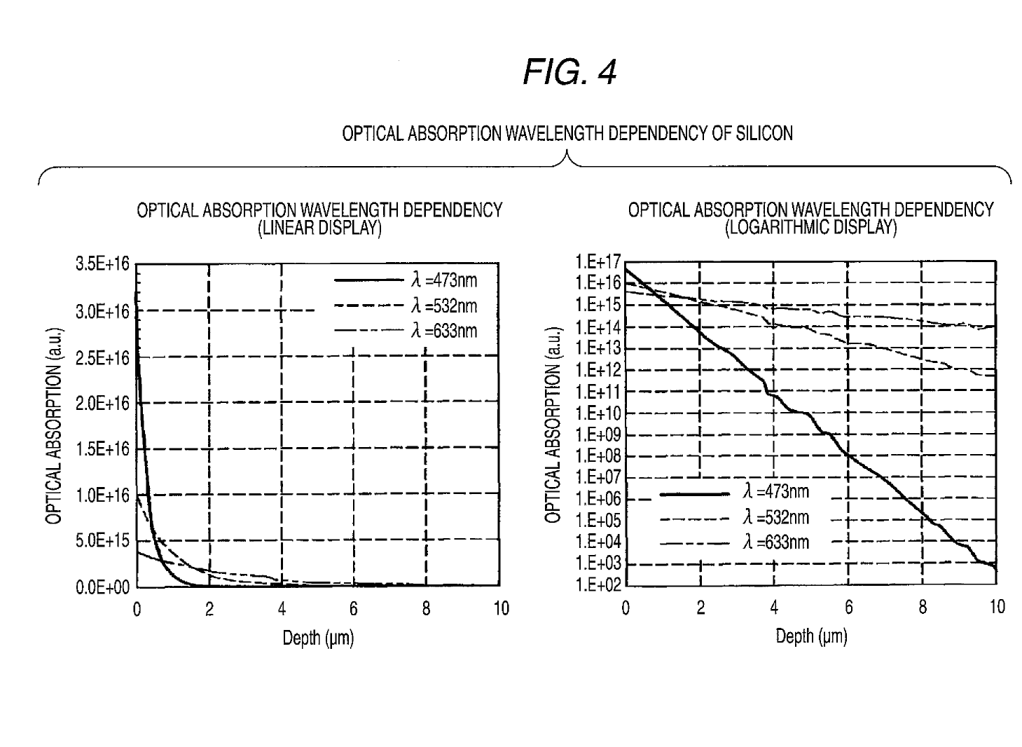

In the second photographing mode, the mechanical shutter MS is not used. For this reason, there is a problem in that a smear is generated. The smear is generated for various reasons. Most dominantly, the smear is caused by the movement of the charge generated on the surface of the photoelectric converting device 51 to the vertical charge transfer path 52. On the other hand, as shown in FIG. 4, it is found that an optical absorption of a light having a longer wavelength is lessened more greatly over the surface of the silicon and the optical absorption is correspondingly carried out in a deep part of the silicon. In other words, it is found that an optical absorption of a light having a short wavelength is more increased over the surface of the silicon. More specifically, it is apparent that more smear charges are generated on the surface of the B photoelectric converting device 51 having a large optical absorption on the surface than those in the R photoelectric converting device 51 and the G photoelectric converting device 51.

According to the smear suppression driving operation, for the horizontal transfer period, the charge is caused to stand by in the vertical charge transfer path 52 provided below the transfer electrodes (V1, V4) other than the transfer electrodes V2 and V3 which are adjacent to the B photoelectric converting device 51 for detecting a light having a short wavelength in which the smear charge is increased most greatly. Therefore, a transfer pulse having a low level can be applied to the transfer electrodes V2 and V3 which are adjacent to the B photoelectric converting device 51 in which a large number of smear charges are generated. The smear charge is negative. By the application of a negative voltage to the transfer electrodes V2 and V3, therefore, the movement of the smear charge from the surface of the B photoelectric converting device 51 to the vertical charge transfer path 52 is suppressed. There is a possibility that the smear charges generated on the surfaces of the R photoelectric converting device 51 and the G photoelectric converting device 51 might be mixed into the charges which are caused to stand by. However, an amount of the smear charges is sufficiently smaller than that of the smear charges generated on the surface of the B photoelectric converting device 51. By causing the charge to stand by except for the portion provided below the adjacent transfer electrode to the B photoelectric converting device 51 for the horizontal transfer period, therefore, it is possible to considerably decrease the smear. According to the digital camera in accordance with the embodiment, thus, it is possible to reduce the smear by only changing a driving method without adding a special circuit.

Although the description has been given to the example in which the 4-phase driving operation is carried out over the vertical charge transfer path 52, this is not restricted but an 8-phase driving operation can also be employed, for example. In case of the 8-phase driving operation, referring to a general driving method, it is possible to transfer a charge by setting, as electrodes for a charge storage, six of eight transfer electrodes to which 8-eight pulses are applied and setting two of them as electrodes for a barrier. Therefore, it is possible to maintain a saturation capacity of the photoelectric converting device 51 (a maximum amount of charges which can be stored) corresponding to a storage capacity of the vertical charge transfer path 52 provided below the six transfer electrodes (a maximum amount of charges which can be stored). In the case in which the smear suppression driving operation is employed, however, there is restricted a place in which the charge is caused to stand by for the horizontal transfer period. For this reason, it is impossible to sufficiently maintain the saturation capacity of the photoelectric converting device 51.

Also in the second photographing mode, consequently, it is preferable to execute a conventionally general driving operation in place of the smear suppression driving operation in the case in which the saturation capacity of the photoelectric converting device 51 is larger than the storage capacity of the charge storing packet for causing the charge to stand by for the horizontal transfer period. Thus, it is possible to read all of the charges stored in the photoelectric converting device 51 without waste.

The saturation capacity of the photoelectric converting device 51 can be varied based on a value of an overflow drain (OFD) voltage to be applied to a silicon substrate. Therefore, there is held, in the digital camera, a value of the OFD voltage with which the storage capacity of the charge storing packet for causing the charge to stand by for the horizontal transfer period is equal to the saturation capacity of the photoelectric converting device 51. In the second photographing mode, it is preferable that the imaging device driving portion 10 should execute the smear suppression driving operation when the value of the OFD voltage based on a set photographing condition is equal to or greater than the voltage value held in the camera and should execute the general driving operation for maintaining the transfer capacity of the vertical charge transfer path 52 when the value of the OFD voltage is smaller than the voltage value held in the camera.

In the description, moreover, the smear suppression driving operation is carried out in only the second photographing mode. However, the second photographing mode is not restricted but it is also possible to employ a structure in which the conventionally general driving operation is executed when the saturation capacity of the photoelectric converting device 51 is larger than the storage capacity of the charge storing packet for causing the charge to stand by for the horizontal transfer period and the smear suppression driving operation is executed when the saturation capacity of the photoelectric converting device 51 is equal to or smaller than the storage capacity of the charge storing packet in all of the photographing modes.

### Second Embodiment

In the first embodiment, the smear suppression driving operation is executed in the second photographing mode. However, a digital camera according to the embodiment has a structure in which a smear suppression driving operation is executed in only a situation in which a smear is generated and a conventionally general driving operation is executed in a situation in which the smear is not generated in all photographing modes. A whole structure of the digital camera according to the embodiment is shown in FIG. 1. A system control portion 11 of the digital camera according to the embodiment has a deciding function for deciding whether or not a smear is generated based on an imaging signal output from an imaging device 5 through a preliminary imaging operation (an imaging operation for carrying out autofocusing or an imaging operation for acquiring a through image) to be performed before a main imaging operation in a state in which a first or second photographing mode is set. An imaging device driving portion 10 of the digital camera according to the embodiment executes the smear suppression driving operation if it is decided that the smear is generated by the deciding function and executes a conventional driving operation if it is decided that the smear is not generated.

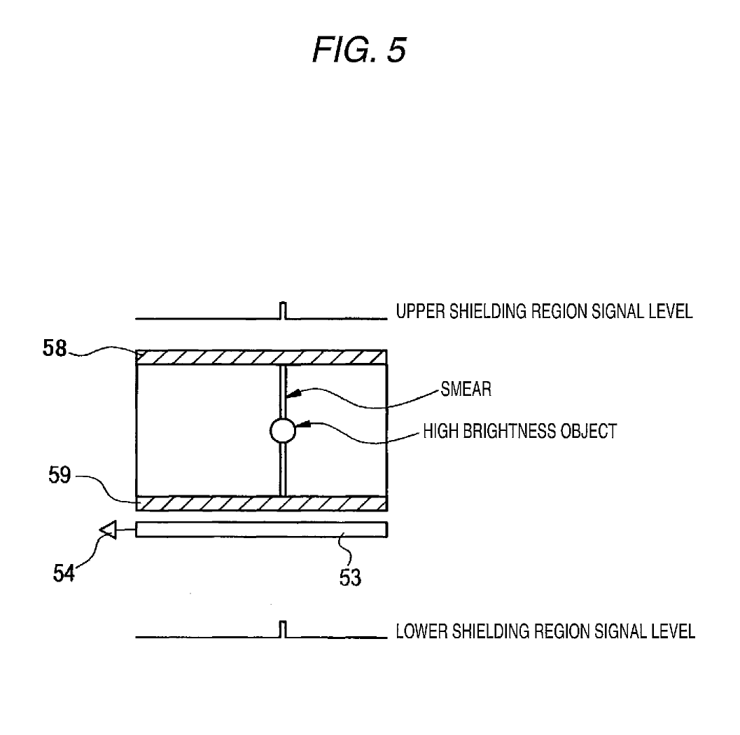

Examples of the method of deciding whether the smear is generated or not include a method of providing an upper shielding region 58 and a lower shielding region 59 which shield a photoelectric converting device 51 on both ends in a vertical direction of the imaging device 5 and making a decision based on signals obtained from the photoelectric converting devices 51 of the upper shielding region 58 and the lower shielding region 59 as shown in FIG. 5. In the case in which levels of the signals obtained from the photoelectric converting devices 51 of the upper shielding region 58 and the lower shielding region 59 are locally high as shown in FIG. 5, it is supposed that the smear is generated in that portion. Therefore, the system control portion 11 can decide presence of the generation of the smear by monitoring the signals.

By executing the smear suppression driving operation only when the smear is generated, thus, it is possible to execute, at a minimum, the smear suppression driving operation in which a saturation capacity of the photoelectric converting device 51 is decreased. Therefore, it is possible to reliably suppress the smear without greatly limiting the saturation capacity of the photoelectric converting device 51.

### Third Embodiment

In the embodiment, description will be given to an example of another structure of an imaging device to which a smear suppression driving operation can be applied and the details of the smear suppression driving operation in the example of the structure. A structure of a digital camera which will be described in the embodiment is the same as that in FIG. 1.

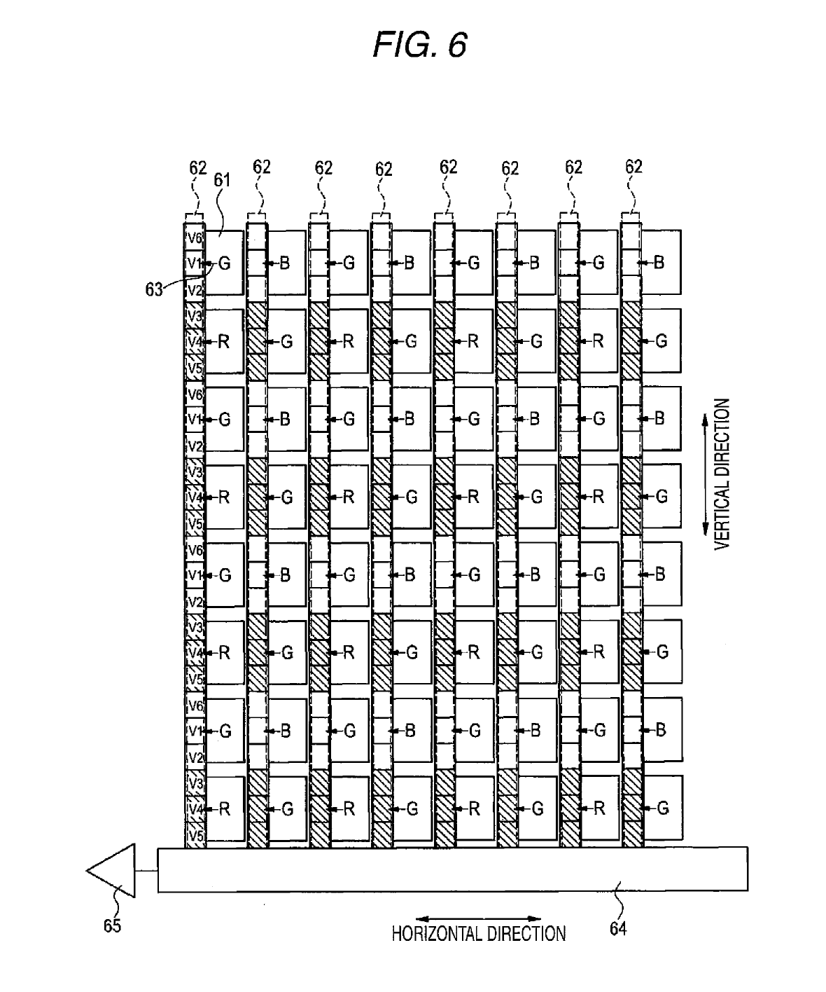

FIG. 6 is a typical plan view showing a schematic structure of an imaging device provided on a digital camera according to a third embodiment.

The imaging device shown in FIG. 6 includes a large number of photoelectric converting devices 61 arranged like a square grid in a vertical direction and a horizontal direction which is orthogonal thereto over a semiconductor substrate, a vertical charge transfer path 62 provided in a left side part corresponding to a photoelectric converting device line constituted by the photoelectric converting devices 61 arranged in the vertical direction and serving to transfer a charge stored in each of the photoelectric converting devices 61 of the photoelectric converting device line in the vertical direction, a charge reading portion 63 (shown typically in an arrow in the drawing) for reading the charge stored in the photoelectric converting device 61 onto the vertical charge transfer path 62 corresponding to the photoelectric converting device 61, a horizontal charge transfer path 64 for transferring the charge transferred through the vertical charge transfer path 62 in the horizontal direction, and an output portion 65 for converting the charge transferred through the horizontal charge transfer path 64 into a voltage signal and outputting the voltage signal.

A color filter is provided above each of the photoelectric converting devices 61 and is arranged in the Bayer array. In FIG. 6, “R” is given to an R photoelectric converting device 61 to be a photoelectric converting device provided with a color filter for transmitting an R light thereabove, “G” is given to a G photoelectric converting device 61 to be a photoelectric converting device provided with a color filter for transmitting a G light thereabove, and “B” is given to a B photoelectric converting device 61 to be a photoelectric converting device provided with a color filter for transmitting a B light thereabove.

Transfer electrodes V1 to V6 are arranged in the vertical direction above the vertical charge transfer path 62 and a 6-phase transfer pulse is applied thereto so that a charge transfer operation in the vertical charge transfer path 62 is controlled. Three transfer electrodes are provided adjacently in each of the photoelectric converting devices 61. The charge reading portion 63 is provided below the transfer electrodes V1 and V4, and a reading pulse having a high level is applied to the transfer electrodes V1 and V4 so that the charge reading operation is controlled.

Description will be given to an operation to be carried out when the imaging device having the structure is to be driven through a smear suppression driving operation.

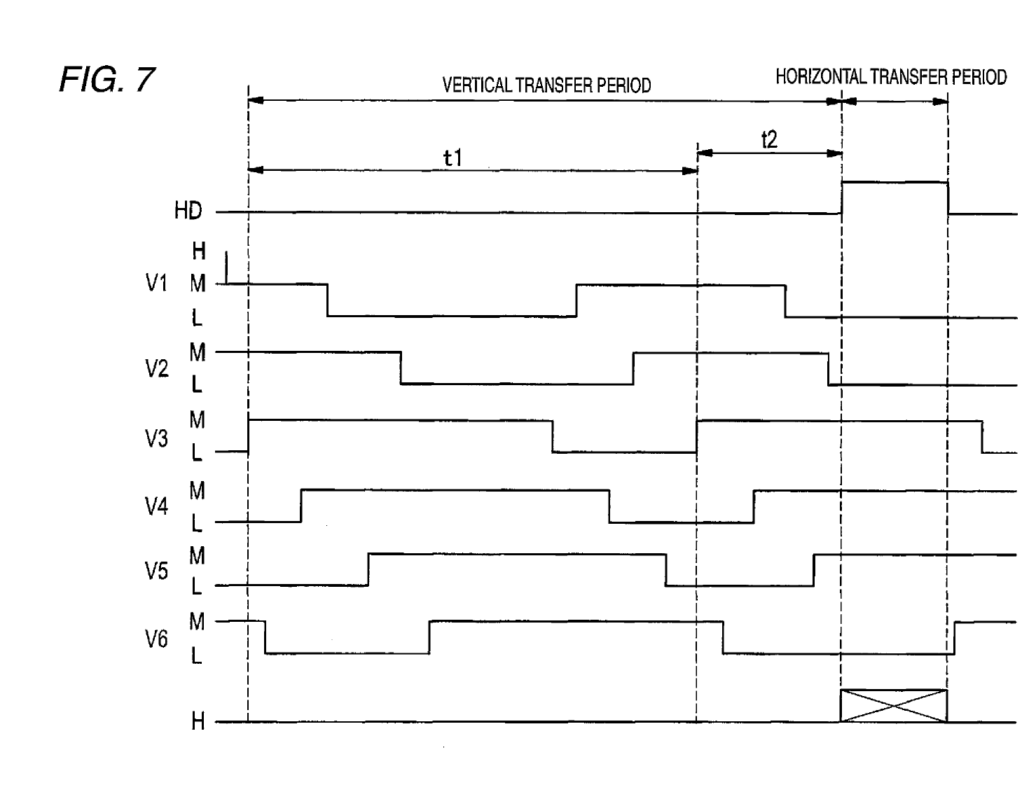

FIG. 7 is a timing chart for a transfer pulse supplied from an imaging device driving portion 10 to an imaging device according to the third embodiment when the imaging device is driven through the smear suppression driving operation.

After an exposing period is ended, electric potentials of the transfer electrodes V6, V1 and V2 are set to have a middle level so that a packet is formed in the vertical charge transfer paths 62 provided below the transfer electrodes V6, V1 and V2. Then, the electric potential of the transfer electrode V1 is set to have a high level so that charges supplied from the G photoelectric converting devices 61 and the B photoelectric converting devices 61 which are provided in odd-numbered lines are stored in the packet. Next, the transfer pulse is controlled for a period t1 so that the packet is transferred to portions provided below the transfer electrodes V6, V1 and V2 which are adjacent to the C photoelectric converting device 61 and the B photoelectric converting device 61 provided adjacently on a downstream side in the charge transfer direction of the G photoelectric converting device 61 and the B photoelectric converting device 61. Furthermore, the transfer pulse is controlled for a period t2 so that the packet is transferred to portions provided below the transfer electrodes V3, V4 and V5 provided adjacently on the downstream side in the charge transfer direction of the transfer electrodes V6, V1 and V2. A period obtained by connecting the periods t1 and t2 is referred to as a vertical transfer period.

For the vertical transfer period, the charges read from the photoelectric converting devices 61 corresponding to one line are transferred to the horizontal charge transfer path 64. Then, a horizontal transfer period is started by a rise of a horizontal synchronizing signal HD and a 2-phase transfer pulse is applied to the horizontal charge transfer path 64, for example, and the charge transferred to the horizontal charge transfer path 64 is transferred to the output portion 65 and a signal corresponding to the transferred charge is output from the output portion 65. For the horizontal transfer period, the charges read from the photoelectric converting devices 61 in odd-numbered lines are brought into a state in which they stand by in the vertical charge transfer paths 62 provided below the transfer electrodes V3, V4 and V5 (portions shown in hatching of FIG. 6).

When the horizontal transfer period is ended by a fall of the horizontal synchronizing signal, there is started a second vertical transfer period in which the packets present below the transfer electrodes V3, V4 and V5 are transferred to portions provided below the transfer electrodes V3, V4 and V5 which are adjacent on the downstream side in the charge transfer direction of the transfer electrodes V3, V4 and V5. Subsequently, the horizontal transfer period and the second vertical transfer period are repeated alternately so that signals corresponding to the charges supplied from the photoelectric converting devices 61 in the odd-numbered lines are output from the output portion 65 and a reading operation for a first field is thus ended.

When a second field is started, electric potentials of the transfer electrodes V3, V4 and V5 are set to have a middle level so that a packet is formed in the vertical charge transfer paths 62 provided below the transfer electrodes V3, V4 and V5. Then, the electric potential of the transfer electrode V4 is set to have a high level so that charges supplied from the R photoelectric converting devices 61 and the G photoelectric converting devices 61 which are provided in even-numbered lines are stored in the packet. Next, the transfer pulse is controlled for a period T1 so that the packet is transferred to portions provided below the transfer electrodes V3, V4 and V5 which are adjacent to the R photoelectric converting device 61 and the G photoelectric converting device 61 provided adjacently on a downstream side in the charge transfer direction of the R photoelectric converting device 61 and the G photoelectric converting device 61. Furthermore, the transfer pulse is controlled for a period T2 so that the packet is transferred to portions provided below the transfer electrodes V6, V1 and V2 disposed adjacently on the downstream side in the charge transfer direction of the transfer electrodes V3, V4 and V5. A period obtained by connecting the periods T1 and T2 is referred to as a vertical transfer period.

For the vertical transfer period, the charges read from the photoelectric converting devices 61 corresponding to one line are transferred to the horizontal charge transfer path 64. Then, a horizontal transfer period is started by a rise of the horizontal synchronizing signal HD and a 2-phase transfer pulse is applied to the horizontal charge transfer path 64, for example, and the charge transferred to the horizontal charge transfer path 64 is transferred to the output portion 65 and a signal corresponding to the transferred charge is output from the output portion 65. For the horizontal transfer period, the charges read from the photoelectric converting devices 61 in even-numbered lines are brought into a state in which they stand by in the vertical charge transfer paths 62 provided below the transfer electrodes V6, V1 and V2 (portions which are not shown in hatching of FIG. 6).

When the horizontal transfer period is ended by a fall of the horizontal synchronizing signal, there is started a second vertical transfer period in which the packets present below the transfer electrodes V6, V1 and V2 are transferred to portions provided below the transfer electrodes V6, V1 and V2 which are adjacent on the downstream side in the charge transfer direction of the transfer electrodes V6, V1 and V2. Subsequently, the horizontal transfer period and the second vertical transfer period are repeated alternately so that signals corresponding to the charges supplied from the photoelectric converting devices 61 in the even-numbered lines are output from the output portion 65 and a reading operation for the second field is thus ended.

With the structure of the imaging device shown in FIG. 6, similarly, it is possible to execute the smear suppression driving operation described in the first embodiment by carrying out the 2-field reading operation.

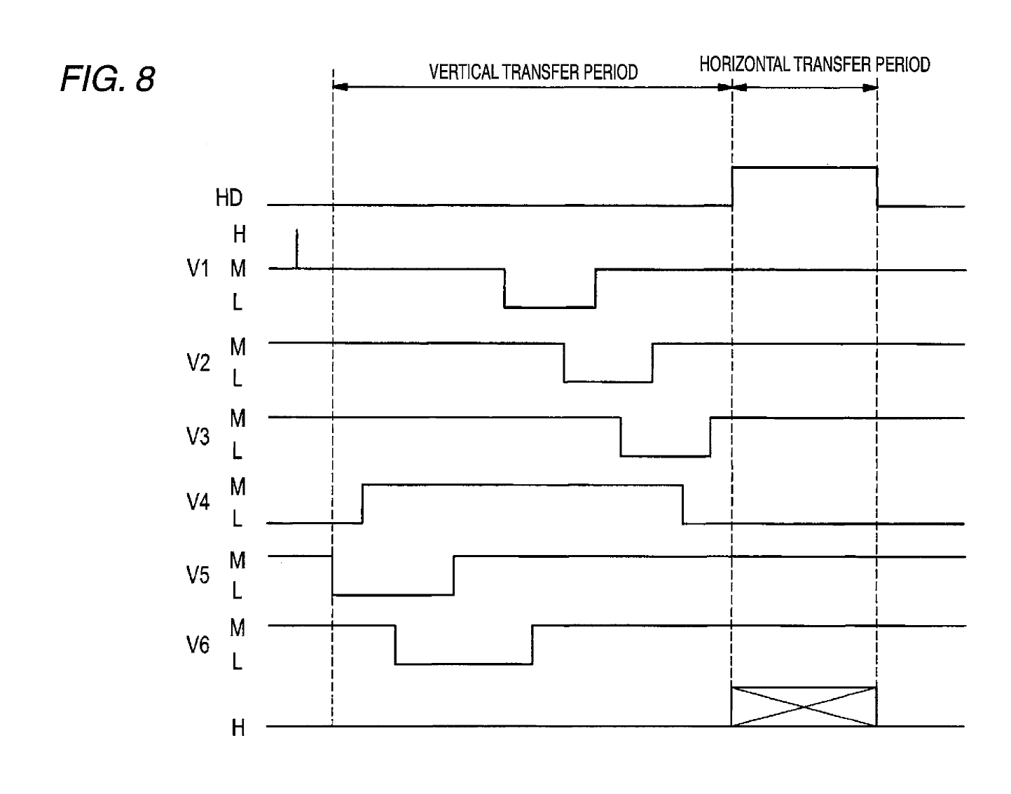

FIG. 8 is a timing chart showing an example of a general driving operation in which a saturation capacity of the photoelectric converting device 61 is maintained in place of the smear suppression driving operation in the imaging device illustrated in FIG. 6.

When a first field is started, electric potentials of the transfer electrodes V5, V6, V1, V2 and V3 are set to have a middle level so that a packet is formed in the vertical charge transfer paths 62 below the transfer electrodes V5, V6, V1, V2 and V3. Then, the electric potential of the transfer electrode V1 is set to have a high level so that charges supplied from the G photoelectric converting devices 61 and the B photoelectric converting devices 61 which are provided in odd-numbered lines are stored in the packet. Next, the transfer pulse is controlled for the vertical transfer period so that the packet is transferred to portions provided below the transfer electrodes V5, V6, V1, V2 and V3 which are disposed adjacently on a downstream side in the charge transfer direction of the transfer electrodes V5, V6, V1, V2 and V3.

For the vertical transfer period, the charges read from the photoelectric converting devices 61 corresponding to one line are transferred to the horizontal charge transfer path 64. Then, a horizontal transfer period is started by a rise of the horizontal synchronizing signal HD and a 2-phase transfer pulse is applied to the horizontal charge transfer path 64, for example, and the charge transferred to the horizontal charge transfer path 64 is transferred to the output portion 65 and a signal corresponding to the transferred charge is output from the output portion 65. For the horizontal transfer period, the charges read from the photoelectric converting devices 61 in even-numbered lines are brought into a state in which they stand by in the vertical charge transfer paths 62 provided below the transfer electrodes V5, V6, V1, V2 and V3.

When the horizontal transfer period is ended by a fall of the horizontal synchronizing signal, a next vertical transfer period is started. Subsequently, the horizontal transfer period and the vertical transfer period are repeated alternately so that signals corresponding to the charges supplied from the photoelectric converting devices 61 in the even-numbered lines are output from the output portion 65 and a reading operation for the first field is thus ended.

When a second field is started, electric potentials of the transfer electrodes V2, V3, V4, V5 and V6 are set to have a middle level so that a packet is formed in the vertical charge transfer path 62 below the transfer electrodes V2, V3, V4, V5 and V6. Then, the electric potential of the transfer electrode V4 is set to have a high level so that charges supplied from the R photoelectric converting devices 61 and the G photoelectric converting devices 61 which are provided in even-numbered lines are stored in the packet. Next, the transfer pulse is controlled for the vertical transfer period so that the packet is transferred to portions provided below the transfer electrodes V2, V3, V4, V5 and V6 which are disposed adjacently on a downstream side in the charge transfer direction of the transfer electrodes V2, V3, V4, V5 and V6.

For the vertical transfer period, the charges read from the photoelectric converting devices 61 corresponding to one line are transferred to the horizontal charge transfer path 64. Then, a horizontal transfer period is started by a rise of the horizontal synchronizing signal HD and a 2-phase transfer pulse is applied to the horizontal charge transfer path 64, for example, and the charge transferred to the horizontal charge transfer path 64 is transferred to the output portion 65 and a signal corresponding to the transferred charge is output from the output portion 65. For the horizontal transfer period, the charges read from the photoelectric converting devices 61 in even-numbered lines are brought into a state in which they stand by in the vertical charge transfer paths 62 provided below the transfer electrodes V2, V3, V4, V5 and V6.

When the horizontal transfer period is ended by a fall of the horizontal synchronizing signal, a next vertical transfer period is started. Subsequently, the horizontal transfer period and the vertical transfer period are repeated alternately so that signals corresponding to the charges supplied from the photoelectric converting devices 61 in the even-numbered lines are output from the output portion 65 and a reading operation for the second field is thus ended.

By executing the driving operation, it is possible to maintain the saturation capacity of the photoelectric converting device 61 corresponding to five transfer electrodes at a maximum.

### Fourth Embodiment

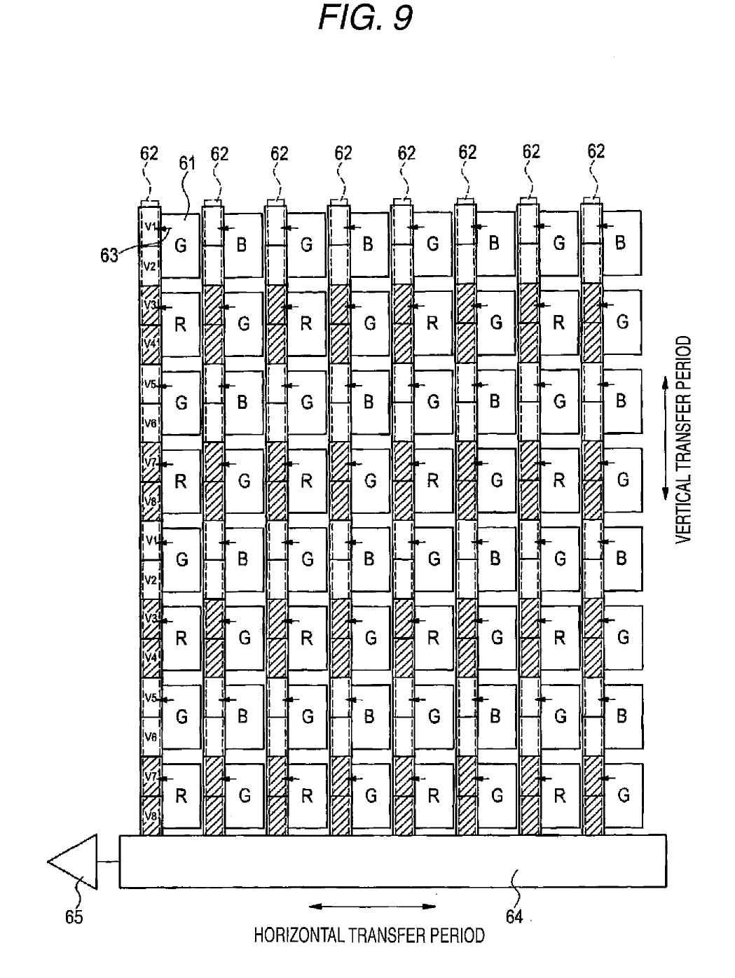

FIG. 9 is a typical plan view showing a schematic structure of an imaging device provided on a digital camera according to a fourth embodiment. In FIG. 9, the same structures as those in FIG. 6 have the same reference numerals. A structure of the digital camera which will be described in the embodiment is the same as that shown in FIG. 1.

The imaging device shown in FIG. 9 has a structure in which the transfer electrodes V1 to V6 in the imaging device shown in FIG. 6 are changed into transfer electrodes V1 to V8. In the imaging device of FIG. 9, two transfer electrodes are adjacent to each photoelectric converting device 61 and a charge reading portion 63 is provided below each of the transfer electrodes V1, V3, V5 and V7.

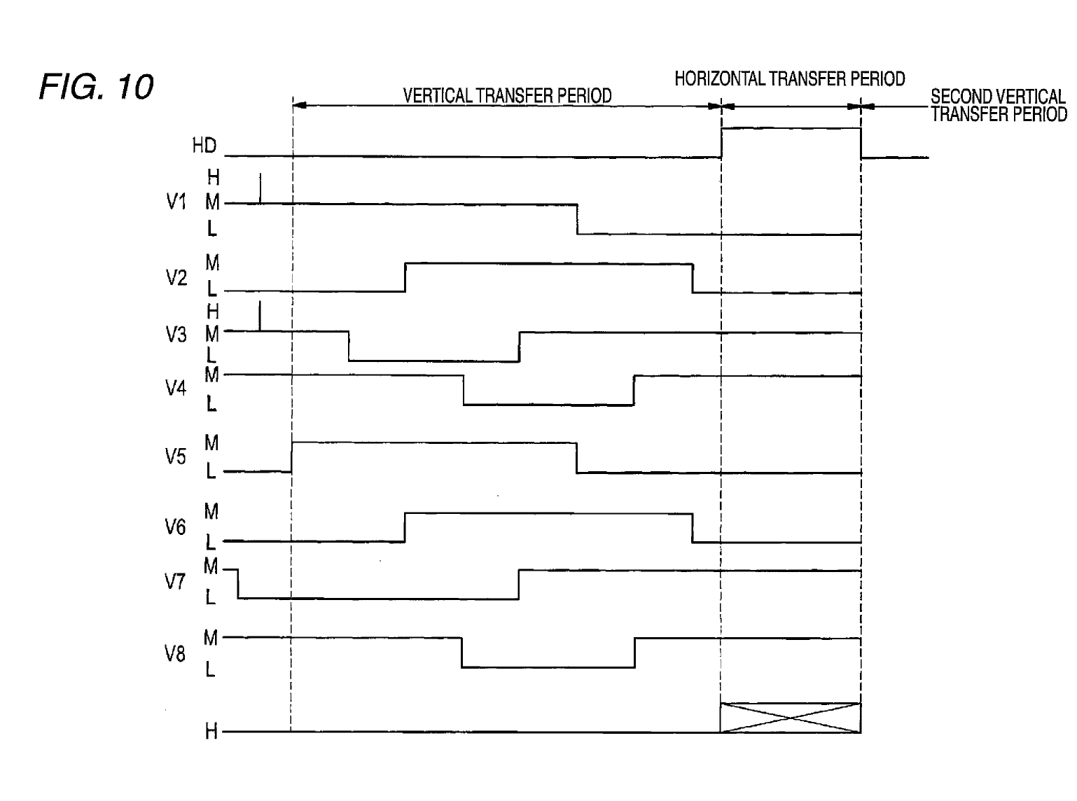

FIG. 10 is a timing chart for a transfer pulse in the case in which the imaging device according to the fourth embodiment is driven through a smear suppression driving operation.

After an exposing period is ended, electric potentials of the transfer electrodes V8, V1, V3 and V1 are set to have a middle level so that a packet is formed in a vertical charge transfer path 62 provided below the transfer electrodes V8, V1, V3 and V4. Then, the electric potentials of the transfer electrodes V1 and V3 are set to have a high level so that a charge supplied from the photoelectric converting device 61 is stored in the packet. Next, a transfer pulse is controlled for a vertical transfer period so that the packet is transferred to portions provided below the transfer electrodes V3, V4, V7 and V8.

For the vertical transfer period, the charges read from the photoelectric converting devices 61 corresponding to one line are transferred to a horizontal charge transfer path 64. Then, a horizontal transfer period is started by a rise of a horizontal synchronizing signal HD and a 2-phase transfer pulse is applied to the horizontal charge transfer path 64, for example, and the charge transferred to the horizontal charge transfer path 64 is transferred to an output portion 65 and a signal corresponding to the transferred charge is output from the output portion 65. For the horizontal transfer period, the charge read from the photoelectric converting device 61 is brought into a state in which it stands by in the vertical charge transfer paths 62 provided below the transfer electrodes V3, V4, V7 and V8 (portions shown in hatching of FIG. 9).

When the horizontal transfer period is ended by a fall of the horizontal synchronizing signal, there is started a second vertical transfer period in which the packets present below the transfer electrodes V3, V4, V7 and V8 are transferred to portions provided below the transfer electrodes V3, V4, V7 and V8 which are adjacent on a downstream side in the charge transfer direction of the transfer electrodes V3, V4, V7 and V8. Subsequently, the horizontal transfer period and the second vertical transfer period are repeated alternately so that signals corresponding to the charges supplied from the photoelectric converting devices 61 every two lines are output from the output portion 65 and an imaging operation corresponding to one frame is ended.

Also in the structure in which two transfer electrodes are provided adjacently for one photoelectric converting device, thus, it is possible to execute the smear suppression driving operation by carrying out a half thinning read operation.

Although the imaging device includes three types of photoelectric converting devices for detecting lights having different wavelength ranges from each other in the embodiments, this is not restricted but two or four types of photoelectric converting devices may be included in the imaging device.

Although the invention has been described above in relation to preferred embodiments and modifications thereof, it will be understood by those skilled in the art that other variations and modifications can be effected in these preferred embodiments without departing from the scope and spirit of the invention.

What is claimed is:

1. A method for driving an imaging device comprising a plurality of photoelectric converting devices for detecting lights in different wavelength ranges from each other, a vertical charge transfer path for transferring charges generated in the photoelectric converting devices in a vertical direction, and a horizontal charge transfer path for transferring the charges transferred through the vertical charge transfer path in a horizontal direction which is orthogonal to the vertical direction,
wherein the imaging device comprises transfer electrodes which are arranged in the vertical direction above the vertical charge transfer path and serve to control a charge transfer operation in the vertical charge transfer path, and
a smear suppression driving operation which applies a transfer pulse to the transfer electrodes to transfer the charge is executed in such a manner that a standby place of the charge in the vertical charge transfer path for a horizontal transfer period for transferring the charge through the horizontal charge transfer path is at the vertical charge transfer path provided below the transfer electrode other than the transfer electrode which is adjacent to any of the photoelectric converting devices which has a detected wavelength on the shortest wavelength side.

2. The method for driving an imaging device according to claim 1, wherein the imaging device comprises a photoelectric converting device for detecting a light in a wavelength range of a red color, a photoelectric converting device for detecting a light in a wavelength range of a green color, and a photoelectric converting device for detecting a light in a wavelength range of a blue color.

3. The method for driving an imaging device according to claim 1, wherein it is possible to select a first photographing mode for controlling an exposing period of the imaging device by using a mechanical shutter and a second photographing mode for controlling the exposing period of the imaging device by means of only an electronic shutter without using the mechanical shutter, and the smear suppression driving operation is executed only in a case in which a photographing operation is carried out in the second photographing mode.

4. The method for driving an imaging device according to claim 1, wherein only in a case in which a saturation capacity of the photoelectric converting device is equal to or smaller than a maximum amount of charges which can be stored in the standby place when the smear suppression driving operation is carried out, the smear suppression driving operation is executed.

5. The method for driving an imaging device according to claim 1, wherein it is possible to select a first photographing mode for controlling an exposing period of the imaging device by using a mechanical shutter and a second photographing mode for controlling the exposing period of the imaging device by means of only an electronic shutter without using the mechanical shutter, and the smear suppression driving operation is executed only in a case in which a photographing operation is carried out in the second photographing mode and a saturation capacity of the photoelectric converting device is equal to or smaller than a maximum amount of charges which can be stored in the standby place in the execution of the smear suppression driving operation.

6. The method for driving an imaging device according to claim 1, comprising:
deciding whether a smear is generated or not based on an imaging signal output from the imaging device through a preliminary imaging operation carried out before a main imaging operation; and
executing the smear suppression driving operation only when the smear is generated.

7. An imaging apparatus comprising: an imaging device comprising a plurality of photoelectric converting devices for detecting lights in different wavelength ranges from each other, a vertical charge transfer path for transferring charges generated in the photoelectric converting devices in a vertical direction, and a horizontal charge transfer path for transferring the charges transferred through the vertical charge transfer path in a horizontal direction which is orthogonal to the vertical direction; and a driving unit for driving the imaging device,
wherein the imaging device comprises transfer electrodes which are arranged in the vertical direction above the vertical charge transfer path and serve to control a charge transfer operation in the vertical charge transfer path, and
the driving unit executes a smear suppression driving operation for applying a transfer pulse to the transfer electrode to transfer the charge in such a manner that a standby place of the charge in the vertical charge transfer path for a horizontal transfer period for transferring the charge through the horizontal charge transfer path is at the vertical charge transfer path provided below the transfer electrode other than the transfer electrode which is adjacent to any of the photoelectric converting devices which has a detected wavelength on the shortest wavelength side.

8. The imaging apparatus according to claim 7, wherein the plurality of photoelectric converting devices comprise a photoelectric converting device for detecting a light in a wavelength range of a red color, a photoelectric converting device for detecting a light in a wavelength range of a green color, and a photoelectric converting device for detecting a light in a wavelength range of a blue color.

9. The imaging apparatus according to claim 7, wherein it is possible to select a first photographing mode for controlling an exposing period of the imaging device by using a mechanical shutter and a second photographing mode for controlling the exposing period of the imaging device by means of only an electronic shutter without using the mechanical shutter, and
the driving unit executes the smear suppression driving operation only in a case in which a photographing operation is carried out in the second photographing mode.

10. The imaging apparatus according to claim 7, wherein only in a case in which a saturation capacity of the photoelectric converting device is equal to or smaller than a maximum amount of charges which can be stored in the standby place when the smear suppression driving operation is carried out, the driving unit executes the smear suppression driving operation.

11. The imaging apparatus according to claim 7, wherein it is possible to select a first photographing mode for controlling an exposing period of the imaging device by using a mechanical shutter and a second photographing mode for controlling the exposing period of the imaging device by means of only an electronic shutter without using the mechanical shutter, and
the driving unit executes the smear suppression driving operation only in a case in which a photographing operation is carried out in the second photographing mode and a saturation capacity of the photoelectric converting device is equal to or smaller than a maximum amount of charges which can be stored in the standby place when the smear suppression driving operation is carried out.

12. The imaging apparatus according to claim 7, further comprising a smear generating presence deciding unit for deciding whether a smear is generated or not based on an imaging signal output from the imaging device through a preliminary imaging operation carried out before a main imaging operation,
the driving unit executing the smear suppression driving operation only when it is decided that the smear is generated by the smear generating presence deciding unit.
